(19) United States
(12) Patent Application Publication
(10) Pub. No.: US 2024/0147195 A1
(43) Pub. Date: May 2, 2024

(54) WIRELESS COMMUNICATION METHOD, TERMINAL DEVICE AND NETWORK DEVICE

(71) Applicant: GUANGDONG OPPO MOBILE TELECOMMUNICATIONS CORP., LTD., Dongguan (CN)

(72) Inventors: Rongyi Hu, Dongguan (CN); Shukun Wang, Dongguan (CN); Jinyu Zhang, Dongguan (CN)

(21) Appl. No.: 18/411,672

(22) Filed: Jan. 12, 2024

Related U.S. Application Data
(63) Continuation of application No. PCT/CN2021/106822, filed on Jul. 16, 2021.

(51) Int. Cl. H04W 4/06; H04W 72/30

(52) U.S. Cl. CPC H04W 4/06; H04W 72/30; H04L 12/189

(57) ABSTRACT

A wireless communication method, a terminal device and a network device are provided. A terminal device transmits first information to a network device, the first information indicating a parameter the terminal device expects the network device to configure for a Multimedia Broadcast Multicast Service (MBMS) transmission. The terminal device reports an expected parameter for transmitting an MBMS service, such that the network device can provide the MBMS service based on the expected parameter of the terminal device, which is beneficial to meet the service requirements of the terminal device.

### CROSS-REFERENCE TO RELATED APPLICATIONS

The application is a continuation of International Application No. PCT/CN2021/106822 filed on Jul. 16, 2021, the entire content of which is incorporated herein by reference.

### TECHNICAL FIELD

The embodiments of the present disclosure relate to communication technology, and more particularly, to a wireless communication method, a terminal device and a network device.

### BACKGROUND

A Multimedia Broadcast Multicast Service (MBMS) is a technology for transmitting data from one data source to a plurality of user equipment over shared network resources. It can effectively utilize network resources while providing multimedia services, and achieve broadcast and multicast of multimedia services at a higher rate (e.g., 256 kbps). Therefore, for a network device, how to schedule transmission of the MBMS service to meet service requirements of a terminal device is a problem to be solved.

### SUMMARY

The present disclosure provides a wireless communication method, a terminal device and a network device. The terminal device reports an expected parameter for transmitting an MBMS service, such that the network device can provide the MBMS service based on the expected parameter of the terminal device, which is beneficial to meet the service requirements of the terminal device.

In a first aspect, a wireless communication method is provided. The method includes: transmitting, by a terminal device, first information to a network device, the first information indicating a parameter the terminal device expects the network device to configure for a Multimedia Broadcast Multicast Service (MBMS) transmission.

In a second aspect, a wireless communication method is provided. The method includes: receiving, by a network device, first information transmitted by a terminal device, the first information indicating a parameter the terminal device expects the network device to configure for a Multimedia Broadcast Multicast Service (MBMS) transmission.

In a third aspect, a terminal device is provided. The terminal device is configured to perform the method according to the above first aspect or any implementation thereof.

In particular, the terminal device includes one or more functional modules configured to perform the method according to the above first aspect or any implementation thereof.

In a fourth aspect, a network device is provided. The network device is configured to perform the method according to the above second aspect or any implementation thereof.

In particular, the network device includes one or more functional modules configured to perform the method according to the above second aspect or any implementation thereof.

In a fifth aspect, a terminal device is provided. The terminal device includes a processor and a memory. The memory has a computer program stored thereon, and the processor is configured to invoke and execute the computer program stored in the memory to perform the method according to the above first aspect or any implementation thereof.

In a sixth aspect, a network device is provided. The network device includes a processor and a memory. The memory has a computer program stored thereon, and the processor is configured to invoke and execute the computer program stored in the memory to perform the method according to the above second aspect or any implementation thereof.

In a seventh aspect, a chip is provided. The chip is configured to perform the method according to any of the above first and second aspects or any implementation thereof.

In particular, the chip includes a processor configured to invoke and execute a computer program from a memory, to cause a device provided with the apparatus to perform the method according to any of the above first and second aspects or any implementation thereof.

In an eighth aspect, a computer-readable storage medium is provided. The computer-readable storage medium stores a computer program that cause a computer to perform the method according to any of the above first and second aspects or any implementation thereof.

In a ninth aspect, a computer program product is provided. The computer program product includes computer program instructions that cause a computer to perform the method according to any of the above first and second aspects or any implementation thereof.

In a tenth aspect, a computer program is provided. The computer program, when executed on a computer, causes the computer to perform the method according to any of the above first and second aspects or any implementation thereof.

With the above technical solutions, the terminal device reports an expected parameter for transmitting an MBMS service, such that the network device can provide the MBMS service based on the expected parameter of the terminal device, which is beneficial to meet the service requirements of the terminal device.

### BRIEF DESCRIPTION OF DRAWINGS

FIG. 1 is a schematic diagram showing a communication system architecture according to an embodiment of the present disclosure.

FIG. 2 is a schematic diagram showing an SC-PTM channel and mapping.

FIG. 3 is a schematic diagram showing an SC-PTM configuration transmission mechanism.

FIG. 4 is a schematic interactive flowchart illustrating a wireless communication method according to an embodiment of the present disclosure.

FIG. 5 is a schematic block diagram of a terminal device according to an embodiment of the present disclosure.

FIG. 6 is a schematic block diagram of a network device according to an embodiment of the present disclosure.

FIG. 7 is a schematic block diagram of a communication device according to an embodiment of the present disclosure.

FIG. 8 is a schematic block diagram of a chip according to an embodiment of the present disclosure.

FIG. 9 is a schematic block diagram of a communication system according to an embodiment of the present disclosure.

### DESCRIPTION OF EMBODIMENTS

The technical solutions in the embodiments of the present disclosure will be described below with reference to the figure in the embodiments of the present disclosure. Obviously, the described embodiments are only some embodiments, rather than all embodiments, of the present disclosure. All other embodiments obtained by those skilled in the art based on the embodiments in the present disclosure without inventive efforts are to be encompassed by the scope of the present disclosure.

The solutions according to the embodiments of the present disclosure can be applied to various communication systems, including for example: Global System of Mobile Communication (GSM), Code Division Multiple Access (CDMA) system, Wideband Code Division Multiple Access (WCDMA) system, General Packet Radio Service (GPRS), Long Term Evolution (LTE) system, Advanced Long Term Evolution (LTE-A) system, New Radio (NR) system, evolved NR system, LTE-based access to unlicensed spectrum (LTE-U) system, NR-based access to unlicensed spectrum (NR-U) system, Non-Terrestrial Network (NTN) system, Universal Mobile Telecommunication System (UMTS), Wireless Local Area Networks (WLAN), Wireless Fidelity (WiFi), the 5^{th} Generation (5G) system, or other communication systems.

Generally, traditional communication systems can support a limited number of connections and are easy to implement. However, with the development of communication technology, mobile communication systems will support not only traditional communication, but also e.g., Device to Device (D2D) communication, Machine to Machine (M2M) communication, and Machine Type Communication (MTC), Vehicle to Vehicle (V2V) communication, Vehicle to everything (V2X) communication, etc. The embodiments of the present disclosure can also be applied to these communication systems.

In some embodiments, the communication system of an embodiment of the present disclosure may be applied to a Carrier Aggregation (CA) scenario, a Dual Connectivity (DC) scenario, a Standalone (SA) network deployment scenario, and the like.

In some embodiments, the communication system of an embodiment of the present disclosure may be applied to unlicensed spectrum or shared spectrum. In some embodiments, the communication system of an embodiment of the present disclosure may be applied to licensed spectrum or non-shared spectrum.

The embodiments of the present disclosure are described in conjunction with a network device and a terminal device. The terminal device may refer to a User Equipment (UE), an access terminal, a user unit, a user station, a mobile station, a remote station, a remote terminal, a mobile device, a user terminal, a terminal, a wireless communication device, a user agent, or a user device. The terminal device may be a station (ST) in a WLAN, a cellular phone, a cordless phone, a Session Initiation Protocol (SIP) phone, a Wireless Local Loop (WLL) station, a Personal Digital Assistant (PDA) device, a handheld device or a computing device having a wireless communication function, another processing device connected to a wireless modem, a vehicle-mounted device, a wearable device, a terminal device in the next generation communication system (e.g., NR network), or a terminal device in a future evolved Public Land Mobile Network (PLMN), etc.

In the embodiments of the present disclosure, the terminal device can be deployed on land, including indoor or outdoor, handheld, worn, or vehicle-mounted, deployed on water (e.g., on a ship), or deployed in the air (e.g., on an airplane, a balloon, a satellite, etc.).

In the embodiments of the present disclosure, the terminal device may be a mobile phone, a tablet computer (Pad), a computer with a wireless transceiver function, a Virtual Reality (VR) terminal device, an Augmented Reality (AR) terminal device, a wireless terminal device in industrial control, a wireless terminal device in self driving, a wireless terminal device in remote medical, a wireless terminal device in smart grid, a wireless terminal device in transportation safety, a wireless terminal device in smart city, or a wireless terminal device in smart home.

As non-limiting examples, in an embodiment of the present disclosure, the terminal device may also be a wearable device. The wearable device, also known as wearable smart device, is a general term for wearable devices that are intelligently designed and developed from everyday wear, such as glasses, gloves, watches, clothes, and shoes, by applying wearable technologies. A wearable device is a portable device that can be directly worn on or integrated into a user's clothes or accessories. A wearable device is not only a kind of hardware device, but can also provide powerful functions based on software support, data interaction, and cloud interaction. In a broad sense, wearable smart devices may include full-featured, large-sized devices that can provide full or partial functions without relying on smart phones, such as smart watches or smart glasses, and devices that only focus on a certain type of application function and need to cooperate with other devices such as smart phones for use, such as various smart bracelets and smart jewelries for physical sign monitoring.

In an embodiment of the present disclosure, the network device may be a device communicating with mobile devices. The network device may be an Access Point (AP) in a WLAN, a base station such as Base Transceiver Station (BTS) in a GSM system or a CDMA system, a base station such as NodeB (NB) in a WCDMA system, a base station such as Evolutional Node (eNB or eNodeB) in an LTE system, or a relay station, an access point, a vehicle-mounted device, a wearable device, a network device or base station (e.g., gNB) in an NR network, a network device in a future evolved PLMN, or a network device in an NTN. As a non-limiting example, in an embodiment of the present disclosure, the network device may have mobile characteristics, e.g., the network device may be a mobile device. In some embodiments, the network device may be a satellite or a balloon station. For example, the satellite may be a Low Earth Orbit (LEO) satellite, a Medium Earth Orbit (MEO) satellite, a Geostationary Earth Orbit (GEO) satellite, a High Elliptical Orbit (HEO) satellite, etc. In some embodiments, the network device may also be a base station provided in a location such as land or water.

In the embodiment of the present disclosure, the network device may provide services for a cell, and the terminal device may communicate with the network device over transmission resources, e.g., frequency domain resources or frequency spectral resources, used in the cell. The cell may be a cell corresponding to the network device (e.g., base station). The cell may belong to a macro base station or a base station corresponding to a small cell. The small cell here may include a metro cell, a micro cell, a pico cell, a femto cell, or the like. These small cells have characteristics such as small coverage and low transmission power, and are suitable for providing high-rate data transmission services.

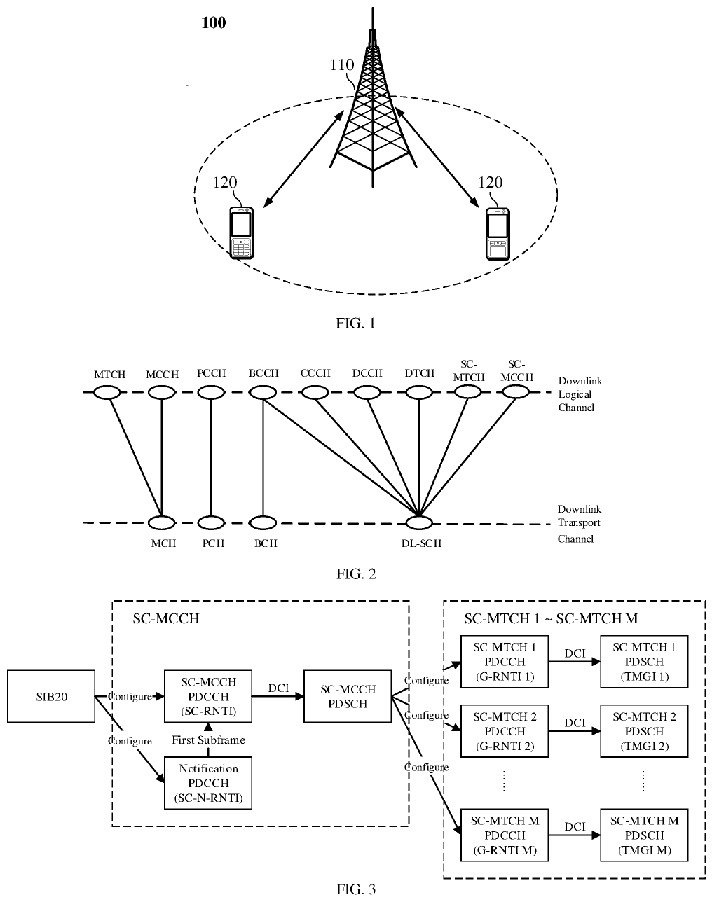

Exemplarily, a communication system 100 in which an embodiment of the present disclosure can be applied is schematically shown in FIG. 1. The communication system 100 may include a network device 110 which may be a device communicating with a terminal device 120 (or referred to as communication terminal or terminal). The network device 110 may provide communication coverage for a particular geographic area, and may communicate with terminal devices located within the coverage.

FIG. 1 exemplarily shows one network device and two terminal devices. In some embodiments, the communication system 100 may include multiple network devices, and the coverage of each network device may include other numbers of terminal devices. The embodiment of the present disclosure is not limited to this.

In some embodiments, the communication system 100 may also include other network entities such as a network controller or a Mobility Management Entity (MME). The embodiment of the present disclosure is not limited to this.

It can be appreciated that, in the embodiments of the present disclosure, a device having a communication function in a network/system may be referred to as a communication device. Taking the communication system 100 shown in FIG. 1 as an example, the communication devices may include the network device 110 and the terminal device 120 with communication functions. The network device 110 and the terminal device 120 may be the specific devices described above, and details thereof will be omitted here. The communication devices may also include other devices in the communication system 100, e.g., other network entities such as a network controller, an MME, etc., and the embodiment of the present disclosure is not limited to any of these examples.

In addition, the terms “system” and “network” may often be used interchangeably herein. The term “and/or” as used herein only represents a relationship between correlated objects, including three relationships. For example, “A and/or B” may mean A only, B only, or both A and B. In addition, the symbol “/” as used herein represents an “or” relationship between the correlated objects preceding and succeeding the symbol.

It can be appreciated that the term “indication” as used in the embodiments of the present disclosure may be a direct indication, an indirect indication, or an association. For example, if A indicates B, it may mean that A directly indicates B, e.g., B can be obtained from A. In some embodiments, it may mean that A indicates B indirectly, e.g., A indicates C and B can be obtained from C. In some embodiments, it may mean that there is an association between A and B.

In the description of the embodiments of the present disclosure, the term “corresponding” may mean that there is a direct or indirect correspondence between the two, or may mean that there is an association between the two, or that they are in a relation of indicating and indicated, configuring or configured, or the like.

In the embodiments of the present disclosure, “predefined” may implemented as pre-stored in one or more devices (for example, including a terminal device and a network device) corresponding codes, tables or other means that can be used to indicate related information, and the present disclosure is not limited to its specific implementation. For example, “predefined” may refer to defined in protocols.

In the embodiments of the present disclosure, “protocols” may refer to standard protocols in the communication field, including e.g., the LTE protocol, the NR protocol, and related protocols applied in future communication systems. The present disclosure is not limited to any of these examples.

A Multimedia Broadcast Multicast Service (MBMS) is a technology for transmitting data from one data source to a plurality of user devices over shared network resources. It can effectively utilize network resources while providing multimedia services, and achieve broadcast and multicast of multimedia services at a higher rate (e.g., 256 kbps).

Due to the low spectrum efficiency of MBMS, it is not enough to effectively carry and support the operation of mobile TV services. It is further proposed to enhance the capability to support downlink high-speed multimedia broadcast multicast service (eMBMS), and determine the design requirements for the physical layer and air interface.

The concept of Single Frequency Network (SFN) is proposed for eMBMS, which uses a unified frequency to transmit data to all cells at the same time, but synchronization between cells needs to be guaranteed. This scheme can greatly improve the overall signal-to-noise ratio distribution of the cell, and the spectrum efficiency can also be greatly improved accordingly. Based on the Internet Protocol (IP) multicast protocol, the broadcast and multicast of services can be achieved.

In the LTE system, the MBMS only has a broadcast bearer mode, no multicast bearer mode.

The reception of an MBMS service is applicable to a terminal device in a connected state (RRC_CONNECTED) or idle state (RRC_IDLE).

In some scenarios, Single Cell Point To Multipoint (SC-PTM) is introduced. The SC-PTM is based on the MBMS network architecture. A Multi-cell/multicast Coordination Entity (MCE) decides to use a SC-PTM transmission mode or a Multimedia Broadcast multicast service Single Frequency Network (MBSFN) transmission mode.

In some scenarios, new logical channels, including Single Cell Multicast Control Channel (SC-MCCH) (LCID=11001) and Single Cell Multicast Transport Channel (SC-MTCH) (LCID=11001), are introduced, as shown in FIG. 2. The SC-MCCH and SC-MTCH are mapped to a transport channel of Downlink Shared Channel (DL-SCH) and a physical channel of Physical Downlink Shared Channel (PDSCH). The SC-MCCH and SC-MTCH do not support Hybrid Automatic Repeat reQuest (HARM) operation and adopt Unacknowledged Mode (UM) Radio Link Control (RLC).

In some scenarios, a new System Information Block (SIB) type is introduced, that is, SIB20 is used to transmit configuration information for an SC-MCCH, and a cell has only one SC-MCCH. The configuration information includes: a modification period, a repetition period (mcch-RepetitionPeriod), and a radio frame and subframe configuration information for the SC-MCCH.

In some embodiments, a radio frame (mcch-Offset) scheduled by an SC-MCCH can be determined according to: SFN mod mcch-RepetitionPeriod=mcch-Offset.

In some embodiments, a subframe scheduled by an SC-MCCH can be indicated by sc-mcch-Subframe.

In some embodiments, an SC-MCCH is only used to transmit one message, SCPTMConfiguration, which is used to configure configuration information of an SC-PTM. A new Radio Network Temporary Identity (RNTI), Single Cell RNTI (C-RNTI) (fixed value FFFC), is introduced to identify scheduling information for an SC-MCCH on a Physical Downlink Control Channel (PDCCH).

In some scenarios, a new RNTI, Single Cell Notification RNTI (SC-N-RNTI) (fixed value FFFB), is introduced to identify a PDCCH for SC-MCCH change notification. One of 8 bits in DCI 1C is used to indicate the change notification. A modification period boundary is defined as SFN mod m=0, where m is the modification period sc-mcch-ModificationPeriod configured in SIB20.

FIG. 3 is a schematic diagram showing an SC-PTM configuration transmission mechanism. The configuration information for the SC-PTM includes a Temporary Mobile Group Identity (TMGI). In some embodiments, it may also include a session id, a group RNTI (G-RNTI), SC-PTM Discontinuous Reception (DRX) configuration information, and SC-PTM service information of neighboring cells.

In some embodiments, the SC-PTM downlink discontinuous reception is controlled by three parameters: SC-PTM continuous timer (onDurationTimerSCPTM), SC-PTM DRX inactivity timer (drx-InactivityTimerSCPTM), and SC-PTM scheduling period and start offset (schedulingPeriodStartOffsetSCPTM).

For example, when [(SFN*10)+subframe number] mod (SC-MTCH-SchedulingCycle)=SC-MTCH-SchedulingOffset is satisfied, the timer onDurationTimerSCPTM is started.

In another example, when downlink PDCCH scheduling is received, the timer drx-InactivityTimerSCPTM is started.

As another example, the downlink SC-PTM service is received only when the timer onDurationTimerSCPTM or drx-InactivityTimerSCPTM is running. In the LTE system, a network device can configure a terminal device to receive an MBMS service at one or more frequencies. In the NR system, the terminal device supports a more flexible frequency range and more flexible physical layer parameters, such as channel bandwidth, Subcarrier Spacing (SCS), and Band Width Part (BWP) parameters. In this case, for the network device, how to schedule transmission of the MBMS service to meet service requirements of the terminal device is a problem to be solved.

In order to facilitate understanding of the technical solutions of the embodiments of the present disclosure, the technical solutions of the present disclosure will be described in detail below with reference to specific embodiments. The above related art can be arbitrarily combined with the technical solutions of the embodiments of the present disclosure as optional solutions, and they all fall within the protection scope of the embodiments of the present disclosure. The embodiments of the present disclosure include at least part of the following contents.

FIG. 4 is a schematic flowchart illustrating a wireless communication method 200 according to an embodiment of the present disclosure. The method 200 can be performed by the terminal device in the communication system shown in FIG. 1. As shown in FIG. 4, the method 200 includes the following contents.

At S210, a terminal device transmits first information to a network device, the first information indicating a parameter the terminal device expects the network device to configure for a Multimedia Broadcast Multicast Service (MBMS) transmission.

In some embodiments of the present disclosure, the terminal device may further report a parameter currently used for the MBMS transmission to the network device. That is, the terminal device may report a relevant parameter currently used for receiving the MBMS service.

In some embodiments, when the terminal device expects the network device to keep using the current parameter to transmit the MBMS service, the terminal device may report the parameter currently used for the MBMS transmission, such as a currently used radio frequency parameter and/or baseband parameter.

In other embodiments of the present disclosure, the terminal device can report to the network device the parameter the terminal device expects the network device to configure for the MBMS transmission, such that the network device can adjust to the corresponding parameter for transmitting the MBMS service, which is conducive to meeting the service requirements of the terminal device.

In some embodiments, the parameter the terminal device expects the network device to configure for the MBMS transmission may include a parameter for the MBMS transmission that the terminal device is interested in. The parameter for the MBMS transmission that the terminal device is interested in may be determined by the terminal device based on its own capabilities or service transmission requirements.

In some embodiments, the first information may further include a parameter for the MBMS transmission that the terminal device is not interested in, or a parameter that is no longer used for receiving an MBMS service, etc.

Based on the above information, the network device can learn the terminal device's requirements for the parameter for the MBMS transmission, and can in turn properly schedule the MBMS service based on the parameter, which is beneficial to meet the terminal device's transmission requirements for the MBMS service.

It should be understood that the first information may include any radio frequency parameter and/or baseband parameter for the MBMS service transmission. The radio frequency parameters and baseband parameters illustrated below are only examples, and the present disclosure is not limited thereto.

In some embodiments of the present disclosure, the first information may include at least one list of MBMS frequencies on which the terminal device expects to receive an MBMS service. That is, the terminal device expects the network device to transmit the MBMS service on the at least one list of MBMS frequencies.

In an embodiment of the present disclosure, the frequencies in the at least one list of MBMS frequencies are frequencies in a frequency band supported by a radio frequency capability of the terminal device.

It should be understood that the present disclosure is not limited to the configuration scheme of the at least one list of MBMS frequencies. The configuration schemes of the list of MBMS frequencies illustrated below are only examples, but the present disclosure is not limited thereto.

In some embodiments, the first information may include a list of MBMS frequencies corresponding to each terminal device.

For example, when the terminal device supports a per-UE measurement gap (perUEgap), the terminal device may report a perUE list of frequencies.

In other embodiments, the first information may include a list of frequencies corresponding to each Frequency Range (FR).

In some implementations, the frequency range may include a first frequency range FR1 and/or a second frequency range FR2, or may further include other frequency ranges introduced in standard evolution, and the present disclosure is not limited thereto.

For example, when the terminal device supports a per FR1 measurement gap (perFR1 gap, that is, an independent gap), the terminal device can report a first list of MBMS frequencies, including at least one frequency in the first frequency range FR1 supported by the terminal device.

In another example, when the terminal device supports a per FR2 measurement gap (perFR2 gap, that is, an independent gap), the terminal device can report a second list of MBMS frequencies, including at least one frequency in the second frequency range FR2 supported by the terminal device.

In some embodiments, the first information may include a list of frequencies corresponding to each band combination (per band combination, or per BC).

For example, the band combination may include a combination of different frequency ranges, such as a combination of a first frequency range FR1 and a second frequency range FR1.

In another example, the band combination may include a combination of different sub-frequency ranges in a same frequency range, for example, a combination of two or more sub-frequency ranges in the first frequency range FR1, or a combination of two or more sub-frequency ranges in the second frequency range FR2.

In another example, the band combination may include a combination of sub-frequency ranges in different frequency ranges, for example, a combination of a sub-frequency range in the first frequency range FR1 and a sub-frequency range in the second frequency range FR2.

It should be understood that in the embodiment of the present disclosure, the band combination belongs to a capability of the terminal device. The terminal device can report a list of frequencies corresponding to a band combination across FRs when it supports the band combination across FRs, or report a list of frequencies corresponding to a band combination in a FR when the terminal device supports the band combination in a same FR, and the present disclosure is not limited to this.

In some embodiments, when reporting the capability information, the terminal device may also report a list of MBMS frequencies corresponding to each band combination (per BC). For example, when the capability information is reported, the band combinations supported by the terminal device and the list of MBMS frequencies corresponding to each band combination may also be reported to the network device.

In some embodiments, the first information may include mode indication information, which indicates a mode to which the at least one list of MBMS frequencies reported by the terminal device is applied, e.g., a Receive Only Mode (ROM), or any mode, etc.

In some embodiments, the first information may include a list of MBMS frequencies for ROM.

In some embodiments, the list of MBMS frequencies for ROM may include at least one of: a list of MBMS frequencies corresponding to each terminal device for ROM; a list of MBMS frequencies corresponding to each frequency range for ROM; or a list of MBMS frequencies corresponding to each band combination for ROM.

In other embodiments of the present disclosure, the first information may include reception priority information of the MBMS service.

It should be understood that the reception priority information of the MBMS service may be at the granularity of frequency list, or at the granularity of system, or at the granularity of frequency list and the system, or may be independent of system and frequency list, and the present disclosure is not limited to any indication granularity of the reception priority of the MBMS service.

In some embodiments, the first information may include first reception priority order information indicating a reception priority order of MBMS services and unicast services.

That is, the first reception priority order information may be independent of system and frequency list. In other words, the reception priority of MBMS services corresponds to reception priorities of all MBMS services (the reception priorities of MBMS services on all frequency lists), and the reception priority of unicast services corresponds to reception priorities of all unicast services.

For example, the first reception priority order information may indicate that the reception priority of MBMS services is higher than that of unicast services. This means that the reception priorities of all MBMS services are higher than the reception priorities of all unicast services.

In other embodiments, the reception priority information of the MBMS service may include second reception priority order information indicating a reception priority order of MBMS services and unicast services on each of the at least one list of MBMS frequencies. That is, the second reception priority order information may be reception priority information at the granularity of frequency list.

In some implementations, the second reception priority order information may include a first bitmap, the first bitmap includes at least one bit each corresponding to a list of MBMS frequencies and each having a value indicating a reception priority order of MBMS services and unicast services on the frequencies in the corresponding list of MBMS frequencies. For example, a value of 1 indicates that the reception priority of MBMS services is higher than that of unicast services on the list of MBMS frequencies; and a value of 0 indicates that the reception priority of MBMS services is lower than that of unicast services on the list of MBMS frequencies.

As an example, if the first bitmap includes 4 bits, corresponding to four lists of MBMS frequencies respectively, the value of the first bitmap is 1110, indicating that the reception priority of unicast services is higher than the reception priority of MBMS services on the first list of frequencies, and the reception priority of MBMS services is higher than the reception priority of unicast services on each of the remaining lists of frequencies.

In other implementations, the second reception priority order information may indicate the reception priority order of MBMS services and unicast services on each frequency point in the at least one list of MBMS frequencies. The specific indication method is similar, and for the sake of brevity, details thereof will be omitted here.

In some embodiments, the reception priority information of the MBMS service may include third reception priority order information indicating a reception priority order of MBMS services and unicast services on a plurality of systems. That is, the third reception priority order information may indicate system-dependent reception priority information corresponding to the services. In other words, the third reception order information has the granularity of system.

For example, the plurality of systems may include an LTE system and an NR system, and the third reception priority order may indicate the priority order of MBMS services and unicast services on the NR system and the LTE system. As an example, the priority order (from high to low) can be MBMS services on the NR system, MBMS services on the LTE system, unicast services on the NR system, and unicast services on the LTE system.

In some implementations, the third reception priority order information may include first indication information and second indication information, and the first indication information indicates a reception priority order of services on the plurality of systems and the second indication information indicates a reception priority order of MBMS services and unicast services. That is, one piece of indication information indicates the priority order of the systems, and another piece of indication information indicates the priority order of the service types.

For example, the plurality of systems may include an NR system and an LTE system. The first indication information may be 1 bit, indicating a reception priority order of services on the two systems. For example, a value of 1 may indicate that the reception priority of services on the NR system is higher than the reception priority of services on the LTE system.

For example, the second indication information may be 1 bit, indicating a reception priority order of MBMS services and unicast services. For example, a value of 1 may indicate that the reception priority of MBMS services is higher than the reception priority of unicast services, and a value of 0 may indicate that the reception priority of MBMS services is lower than the reception priority of unicast services.

In some embodiments, when determining the reception priorities of two services, the determination can be made according to the systems corresponding to the services first, and then according to the types of the services. In some embodiments, the determination can be made based on the types of the services first, and then based on the systems corresponding to the services.

For example, if the first indication information indicates that the reception priority of services on the NR system is higher than the reception priority of services on the LTE system, and the second indication information indicates that the reception priority of MBMS services is higher than the reception priority of unicast services, for the MBMS services on the LTE system and the unicast services on the NR system, a determination can first be made based on the systems corresponding to the services in combination with the first indication information. In this case, it can be determined that the reception priority of the unicast services on the NR system is higher than the reception priority of the MBMS services on the LTE system. In some embodiments, the determination may first be made based on the types of services in combination with the second indication information. In this case, it may be determined that the reception priority of the MBMS services on the LTE system is higher than the reception priority of the unicast services on the NR system.

In other implementations, the third reception priority order information may indicate the reception priority order of services on a plurality of systems. That is, the third reception priority order information may only include the above first indication information. In this case, the priority order information may be applicable to all services on the system, that is, independent of service types.

For example, if the first indication information indicates that the reception priority of services on the NR system is higher than the reception priority of services on the LTE system, it means that the reception priorities of all services on the NR system are higher than the reception priorities of all services on the LTE system.

In still other implementations, the third reception priority order information may indicate the reception priority order of MBMS services and unicast services on each of the plurality of systems.

For example, the third reception priority order information may include a second bitmap, and the second bitmap includes at least one bit each corresponding to a system and each having a value indicating a reception priority of MBMS services and unicast services on the corresponding system. For example, a value of 1 indicates that the reception priority of MBMS services is higher than that of unicast services on this system, and a value of 0 indicates that the reception priority of MBMS services is lower than that of unicast services on this system. If the second bitmap includes 2 bits, corresponding to an NR system (corresponding to B1) and an LTE system (corresponding to B0), respectively, the value of the second bitmap being 10 indicates that the reception priority of the unicast services is higher than the reception priority of the MBMS services on LTE, and the reception priority of the MBMS services is higher than the reception priority of the unicast services on NR.

In some embodiments, the reception priority information of the MBMS service may include fourth reception priority order information indicating a reception priority order of services on at least one list of MBMS frequencies.

That is, the fourth reception priority order information has the granularity of MBMS frequency list. Each piece of priority information is applicable to all services on the list of MSMS frequencies, independent of service types.

For example, if the reception priority of the services on a first list of MBMS frequencies is higher than the reception priority of the services on a second list of MBMS frequencies, then the reception priority of all services on the first list of MBMS frequencies is higher than the reception priority of all services on the second list of MBMS frequencies.

In some embodiments, the fourth reception priority information may be determined according to at least one of: a service load on each list of MBMS frequencies; a type of service on each list of MBMS frequencies; or a Quality of Service (QoS) requirement for a service on each list of MBMS frequencies.

In some embodiments, the types of services on each list of MBMS frequencies may be divided according to modes, for example, including ROM MBMS services and normal mode MBMS services.

In some embodiments, the types of services on each list of MBMS frequencies may be divided according to service contents or QoS requirements. As examples, they can include but not limited to video services, voice, text, and File Transfer Protocol (FTP) services.

For example, if a first MBMS service is transmitted on a first list of frequencies, and a second MBMS service is transmitted on a second list of frequencies, and the QoS requirements of the first MBMS service are higher than the QoS requirements of the second MBMS service, then it can be determined that the reception priority of services on the first list of frequencies is higher than the reception priority of services on the second list of frequencies.

In another example, if the service load on the first list of frequencies is higher than the service load on the second list of frequencies, it may be determined that the reception priority of the services on the first list of frequencies is lower than that of the services on the second list of frequencies.

In yet another example, if the service on the first list of frequencies is a video service and the service on the second list of frequencies is a text service, it can be determined that the reception priority of the service on the first list of frequencies is higher than that of the services on the second list of frequencies.

In some embodiments, the method 200 may further include:
determining, by the terminal device, a target service and/or a target bearer to request the network device to release.

Further, the terminal device may transmit a request message to the network device, and the request message is used to request release of the target bearer and/or the target service.

For example, in the case of transmission congestion, the terminal device may determine the target service and/or target bearer to request to be released by the network device. In some embodiments, based on service requirements, the terminal device may determine the target service and/or target bearer to request to be released by the network device to ensure the transmission of a specific service or the transmission of services on a specific bearer.

In some embodiments, the terminal device may determine the target service and/or the target bearer to request the network device to release according to reception priority information of the MBMS service.

As an implementation, the terminal device may determine the target bearer to request to be released by the network device according to the first reception priority order information. For example, if the first reception priority order information may indicate that the reception priority of MBMS services is higher than the reception priority of unicast services, then the terminal device may determine that the target bearer to request to be released includes all bearers corresponding to the unicast services, or Guaranteed Bit Rate (GBR) bearer corresponding to the unicast services.

As another implementation, the terminal device may determine the target service to request to be released by the network device according to the fourth reception priority order information. For example, in the case of transmission congestion, the terminal device may determine the target service to be released according to the priority order indicated by the fourth reception priority order information. As an example, if the reception priority of the services on the first list of frequencies is higher than the reception priority of the services on the second list of frequencies, the terminal device may determine that the services on the second list of frequencies are services to be released first.

In some embodiments, the request message may be used only to request the network device to release a bearer or service, and which specific bearer or service is to be released may be determined by the network device.

For example, the network device can determine the bearer or service to be released based on the priority order of the services. In some embodiments, the priority order of the services may be determined based on the service types, service loads, service QoS requirements, etc.

In another example, the network device may determine the bearer or service to be released based on the reception priority order information of MBMS services reported by the terminal device. As an example, if the first reception priority order information indicates that the reception priority of MBMS services is higher than the reception priority of unicast services, the network device can release all bearers corresponding to the unicast services, or GBR bearers corresponding to the unicast services. As an example, if the fourth reception priority order information indicates that the reception priority of services on the first list of frequencies is higher than the reception priority of services on the second list of frequencies, the network device may release the services on the second list of frequencies first.

In some embodiments, when the congestion is mitigated, the network device may trigger establishment of the released bearer or service.

In some embodiments, the terminal device may report other baseband parameters and/or other radio frequency parameters for MBMS transmission, or specific baseband parameters and/or radio frequency parameters, to the network device, e.g., corresponding baseband parameters and/or radio frequency parameters based on instructions from the network device, for the network device to adjust to the corresponding parameters to provide MBMS services.

In some embodiments, other baseband parameters and/or other radio frequency parameters reported by the terminal device for MBMS transmission can also be considered as UE capabilities of the terminal device related to MBMS transmission.

In some embodiments, the first information may include at least one of: a center frequency, a Subcarrier Spacing (SCS), an operating bandwidth, or a parameter related to a Bandwidth Part (BWP).

In some embodiments, the terminal device can report an Absolute Radio Frequency Channel Number (ARFCN) corresponding to the center frequency.

In some embodiments, the SCS reported by the terminal device may include one or more in a candidate set {15 kHz, 7.5 kHz, 1.25 kHz, 2.5 kHz, 0.37 kHz}.

In some embodiments of the present disclosure, the parameter related to the BWP may include at least one of: a center frequency of the BWP, an SCS of the BWP, a bandwidth of the BWP, a number of downlink Multiple-Input Multiple-Output (MIMO) layers of the BWP (i.e., DL_MIMOlayerw), or a delay type of BWP switching.

That is, the terminal device reports radio frequency parameters and/or baseband parameters at the granularity of BWP, such that when the network device schedules an MBMS service on a BWP, it can refer to the parameter related to the BWP for scheduling, which is beneficial to meeting the service requirements of the terminal device.

In some embodiments, the delay type of BWP switching may include but not limited to type 1 and type 2, which correspond to fast retuning and slow retuning of radio frequency parameters, respectively.

In some embodiments, parameter retuning time of a radio frequency device (RF retuning time) includes time to receive a bandwidth adaptation instruction, time to retune the frequency and radio frequency bandwidth, and time required for retune devices such as an Analog-to-Digital Converter (ADC), a Digital-to-Analog Converter (DAC) and an Automatic Gain Tracking (AGC).

Operations for retuning different RF parameter require different parameter retuning time. For example, for in-band operation, if the center frequency remains unchanged and only the bandwidth needs to be changed, the required RF retuning time is typically about 20 μs. In another example, for in-band operation, if the center frequency needs to be changed, the required RF retuning time is typically about 50 μs to 200 μs. As another example, the RF retuning time required for an inter-band operation is typically about 900 μs.

In some embodiments of the present disclosure, the first information may include a type of MBMS service the terminal device expects to receive.

In some embodiments, the types of services on each list of MBMS frequencies may be divided according to modes, for example, including ROM MBMS services and normal mode MBMS services.

In some embodiments, the types of services on each list of MBMS frequencies can be divided according to service contents or QoS requirements. As examples, they can include but not limited to video services, voice, text, and File Transfer Protocol (FTP) services.

It should be understood that in the embodiment of the present disclosure, the first information reported by the terminal device can be carried in an Information Element (IE) in the existing signaling, or a new IE can be added to carry the parameter the terminal device expects the network device to configure for MBMS transmission. The present disclosure is not limited to any specific scheme for carrying the first information.

In summary, the terminal device reports the parameter expected to be configured by the network device for MBMS transmission, and further the network device can provide the MBMS service based on the parameter expected by the terminal device, which is conducive to meeting the transmission requirements of the terminal device for the MBMS service.

The method embodiments of the present disclosure have been described in detail above with reference to FIG. 4, and the apparatus embodiments of the present disclosure will be described in detail below with reference to FIG. 5 to FIG. 9. It should be understood that the apparatus embodiments and the method embodiments correspond to each other, and for similar descriptions, reference can be made to the method embodiments.

FIG. 5 shows a schematic block diagram of a terminal device 400 according to an embodiment of the present disclosure. As shown in FIG. 5, the terminal device 400 includes:

a communication unit 410 configured to transmit first information to a network device, the first information indicating a parameter the terminal device expects the network device to configure for a Multimedia Broadcast Multicast Service (MBMS) transmission.

In some embodiments of the present disclosure, the first information may include at least one list of MBMS frequencies on which the terminal device expects to receive an MBMS service.

In some embodiments of the present disclosure, the at least one list of MBMS frequencies may include at least one of: a list of MBMS frequencies corresponding to each terminal device; a list of MBMS frequencies corresponding to each frequency range; a list of MBMS frequencies corresponding to each band combination; or at least one list of MBMS frequencies for an MBMS receive only mode.

In some embodiments of the present disclosure, the at least one list of MBMS frequencies for the MBMS receive only mode may include at least one of: a list of MBMS frequencies corresponding to each terminal device for the MBMS receive only mode; a list of MBMS frequencies corresponding to each frequency range for the MBMS receive only mode; or a list of MBMS frequencies corresponding to each band combination for the MBMS receive only mode.

In some embodiments of the present disclosure, the list of MBMS frequencies corresponding to each terminal device may include at least one frequency within a frequency band supported by the terminal device.

In some embodiments of the present disclosure, the list of MBMS frequencies corresponding to each frequency range may include at least one of:
a first list of MBMS frequencies including at least one frequency within a first frequency range supported by the terminal device; or
a second list of MBMS frequencies including at least one frequency within a second frequency range supported by the terminal device.

In some embodiments of the present disclosure, the first information may include reception priority information of the MBMS service.

In some embodiments of the present disclosure, the reception priority information of the MBMS service may include first reception priority order information indicating a reception priority order of MBMS services and unicast services.

In some embodiments of the present disclosure, the reception priority information of the MBMS service may include second reception priority order information indicating a reception priority order of MBMS services and unicast services on each of the at least one list of MBMS frequencies.

In some embodiments of the present disclosure, the second reception priority order information may include a first bitmap, the first bitmap including at least one bit each corresponding to a list of MBMS frequencies and each having a value indicating a reception priority order of MBMS services and unicast services on the frequencies in the corresponding list of MBMS frequencies.

In some embodiments of the present disclosure, the reception priority information of the MBMS service may include third reception priority order information indicating a reception priority order of MBMS services and unicast services on a plurality of systems.

In some embodiments of the present disclosure, the third reception priority order information may include first indication information and second indication information, the first indication information indicating a reception priority order of services on the plurality of systems and the second indication information indicating a reception priority order of MBMS services and unicast services.

In some embodiments of the present disclosure, the reception priority information of the MBMS service may include fourth reception priority order information indicating a reception priority order of services on at least one list of MBMS frequencies.

In some embodiments of the present disclosure, the fourth reception priority order information may be determined according to at least one of:
a service load on each list of MBMS frequencies;
a type of service on each list of MBMS frequencies; or
a Quality of Service (QoS) requirement for a service on each list of MBMS frequencies.

In some embodiments of the present disclosure, the terminal device 400 may further include:
a processing unit configured to determine a target service and/or a target bearer to request the network device to release.

In some embodiments of the present disclosure, the processing unit may be configured to:
determine the target service and/or the target bearer to request the network device to release according to reception priority information of the MBMS service.

In some embodiments of the present disclosure, the communication unit 410 may be further configured to: transmit a request message to the network device, the request message being used to request release of the target bearer and/or the target service.

In some embodiments of the present disclosure, the first information may include at least one of: a center frequency, a Subcarrier Spacing (SCS), an operating bandwidth, or a parameter related to a Bandwidth Part (BWP).

In some embodiments of the present disclosure, the parameter related to the BWP may include at least one of: a center frequency of the BWP, an SCS of the BWP, a bandwidth of the BWP, a number of downlink Multiple-Input Multiple-Output (MIMO) layers of the BWP, or a delay type of BWP switching.

In some embodiments of the present disclosure, the first information may include a type of MBMS service the terminal device expects to receive.

In some embodiments, the above communication unit may be a communication interface or a transceiver, or an input/output interface of a communication chip or a system-on-chip. The above processing unit may be one or more processors.

It should be understood that the terminal device 400 according to the embodiment of the present disclosure may correspond to the terminal device in the method embodiment of the present disclosure, and the above and other operations and/or functions of the respective units in the terminal device 400 are provided for the purpose of implementing the processes corresponding to the terminal device in the method 200 shown in FIG. 2, and details thereof will be not omitted here for brevity.

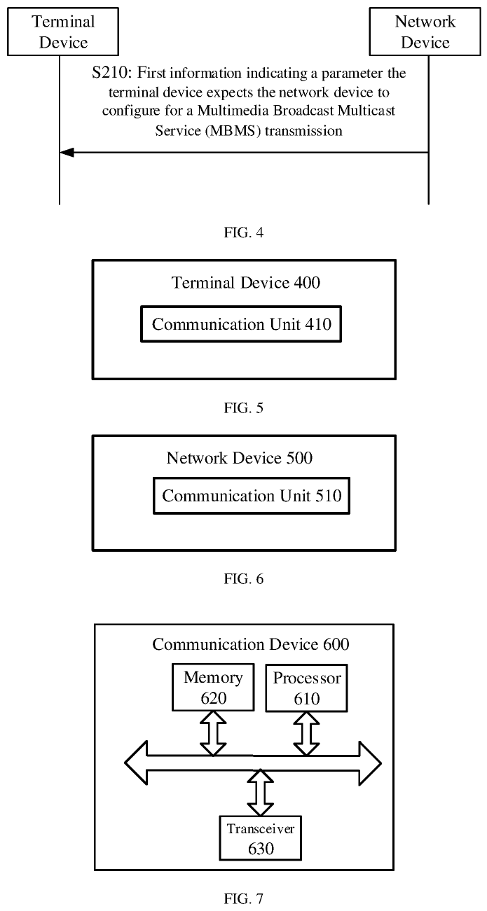

FIG. 6 shows a schematic block diagram of a network device according to an embodiment of the present disclosure. As shown in FIG. 6, the network device 500 includes:
a communication unit 510 configured to receive first information transmitted by a terminal device, the first information indicating a parameter the terminal device expects the network device to configure for a Multimedia Broadcast Multicast Service (MBMS) transmission.

In some embodiments of the present disclosure, the first information may include at least one list of MBMS frequencies on which the terminal device expects to receive an MBMS service.

In some embodiments of the present disclosure, the at least one list of MBMS frequencies may include at least one of: a list of MBMS frequencies corresponding to each terminal device; a list of MBMS frequencies corresponding to each frequency range; a list of MBMS frequencies corresponding to each band combination; or at least one list of MBMS frequencies for an MBMS receive only mode.

In some embodiments of the present disclosure, the at least one list of MBMS frequencies for the MBMS receive only mode may include at least one of: a list of MBMS frequencies corresponding to each terminal device for the MBMS receive only mode; a list of MBMS frequencies corresponding to each frequency range for the MBMS receive only mode; or a list of MBMS frequencies corresponding to each band combination for the MBMS receive only mode.

In some embodiments of the present disclosure, the list of MBMS frequencies corresponding to each terminal device may include at least one frequency within a frequency band supported by the terminal device.

In some embodiments of the present disclosure, the list of MBMS frequencies corresponding to each frequency range may include at least one of: a first list of MBMS frequencies including at least one frequency within a first frequency range supported by the terminal device; or a second list of MBMS frequencies including at least one frequency within a second frequency range supported by the terminal device.

In some embodiments of the present disclosure, the first information may include reception priority information of the MBMS service.

In some embodiments of the present disclosure, the reception priority information of the MBMS service may include first reception priority order information indicating a reception priority order of MBMS services and unicast services.

In some embodiments of the present disclosure, the reception priority information of the MBMS service may include second reception priority order information indicating a reception priority order of MBMS services and unicast services on each of the at least one list of MBMS frequencies.

In some embodiments of the present disclosure, the second reception priority order information may include a first bitmap, the first bitmap including at least one bit each corresponding to a list of MBMS frequencies and each having a value indicating a reception priority order of MBMS services and unicast services on the frequencies in the corresponding list of MBMS frequencies.

In some embodiments of the present disclosure, the reception priority information of the MBMS service may include third reception priority order information indicating a reception priority order of MBMS services and unicast services on a plurality of systems.

In some embodiments of the present disclosure, the third reception priority order information may include first indication information and second indication information, the first indication information indicating a reception priority order of services on the plurality of systems and the second indication information indicating a reception priority order of MBMS services and unicast services.

In some embodiments of the present disclosure, the reception priority information of the MBMS service may include fourth reception priority order information indicating a reception priority order of services on at least one list of MBMS frequencies.

In some embodiments of the present disclosure, the fourth reception priority order information may be determined according to at least one of: a service load on each list of MBMS frequencies; a type of service on each list of MBMS frequencies; or a Quality of Service (QoS) requirement for a service on each list of MBMS frequencies.

In some embodiments of the present disclosure, the first information may include at least one of: a center frequency, a Subcarrier Spacing (SCS), an operating bandwidth, or a parameter related to a Bandwidth Part (BWP).

In some embodiments of the present disclosure, the parameter related to the BWP may include at least one of: a center frequency of the BWP, an SCS of the BWP, a bandwidth of the BWP, a number of downlink Multiple-Input Multiple-Output (MIMO) layers of the BWP, or a delay type of BWP switching.

In some embodiments of the present disclosure, the first information may include a type of MBMS service the terminal device expects to receive.

In some embodiments of the present disclosure, the communication unit 510 may be further configured to receive a request message transmitted by the terminal device, the request message being used to request release of a target bearer and/or a target service.

In some embodiments, the above communication unit may be a communication interface or a transceiver, or an input/output interface of a communication chip or a system-on-chip. The above processing unit may be one or more processors.

It should be understood that the network device 500 according to the embodiment of the present disclosure may correspond to the network device in the method embodiment of the present disclosure, and the above and other operations and/or functions of the respective units in the network device 500 are provided for the purpose of implementing the processes corresponding to the network device in the method 200 shown in FIG. 4, and details thereof will be not omitted here for brevity.

FIG. 7 is a schematic diagram showing a structure of a communication device 600 according to an embodiment of the present disclosure. The communication device 600 shown in FIG. 7 includes a processor 610, and the processor 610 can invoke and execute a computer program from a memory to implement the method in the embodiment of the present disclosure.

In some embodiments, as shown in FIG. 7, the communication device 600 may further include a memory 620. The processor 610 can invoke and execute a computer program from the memory 620 to implement the method in the embodiment of the present disclosure.

The memory 620 may be a separate device independent from the processor 610, or may be integrated in the processor 610.

In some embodiments, as shown in FIG. 7, the communication device 600 may further include a transceiver 630, and the processor 610 may control the transceiver 630 to communicate with other devices, and in particular, transmit information or data to other devices, or receive information or data transmitted by other devices.

Here, the transceiver 630 may include a transmitter and a receiver. The transceiver 630 may further include one or more antennas.

In some embodiments, the communication device 600 may specifically be the network device according to the embodiment of the present disclosure, and the communication device 600 may implement the corresponding processes implemented by the network device in any of the methods according to the embodiments of the present disclosure. For the sake of brevity, details thereof will be omitted here.

In some embodiments, the communication device 600 may specifically be the mobile terminal/terminal device according to the embodiment of the present disclosure, and the communication device 600 may implement the corresponding processes implemented by the mobile terminal/terminal device in any of the methods according to the embodiments of the present disclosure. For the sake of brevity, details thereof will be omitted here.

FIG. 8 is a schematic diagram showing a structure of a chip according to an embodiment of the present disclosure. The chip 700 shown in FIG. 8 includes a processor 710, and the processor 710 can invoke and execute a computer program from a memory to implement the method in the embodiment of the present disclosure.

In some embodiments, as shown in FIG. 8, the chip 700 may further include a memory 720. The processor 710 can invoke and execute a computer program from the memory 720 to implement the method in the embodiment of the present disclosure.

The memory 720 may be a separate device independent from the processor 710, or may be integrated in the processor 710.

In some embodiments, the chip 700 may further include an input interface 730. The processor 710 can control the input interface 730 to communicate with other devices or chips, and in particular, obtain information or data transmitted by other devices or chips.

In some embodiments, the chip 700 may further include an output interface 740. The processor 710 can control the output interface 740 to communicate with other devices or chips, and in particular, output information or data to other devices or chips.

In some embodiments, the chip can be applied to the network device in the embodiment of the present disclosure, and the chip can implement the corresponding processes implemented by the network device in the various methods of the embodiments of the present disclosure. For the sake of brevity, details thereof will be omitted here.

In some embodiments, the chip can be applied to the mobile terminal/terminal device in the embodiment of the present disclosure, and the chip can implement the corresponding processes implemented by the mobile terminal/terminal device in the various methods of the embodiments of the present disclosure. For the sake of brevity, details thereof will be omitted here.

It can be appreciated that the chip in the embodiment of the present disclosure may also be referred to as a system-level chip, a system-chip, a chip system, or a system-on-chip.

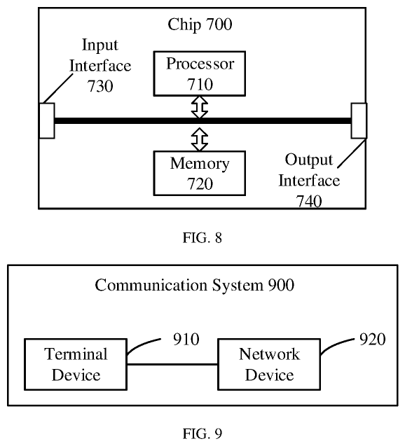

FIG. 9 is a schematic block diagram showing a communication system 900 according to an embodiment of the present disclosure. As shown in FIG. 9, the communication system 900 includes a terminal device 910 and a network device 920.

Here, the terminal device 910 can be configured to implement the corresponding functions implemented by the terminal device in the above method, and the network device 920 can be configured to implement the corresponding functions implemented by the network device in the above method. For the sake of brevity, details thereof will be omitted here.

It is to be noted that the processor in the embodiment of the present disclosure may be an integrated circuit chip with signal processing capability. In an implementation, the operations of the above method embodiments can be implemented by hardware integrated logic circuits in a processor or instructions in the form of software. The processor can be a general purpose processor, a Digital Signal Processor (DSP), an Application Specific Integrated Circuit (ASIC), a Field Programmable Gate Array (FPGA) or another programmable logic device, a discrete gate or transistor logic device, or a discrete hardware component. The methods, operations, and logical block diagrams disclosed in the embodiments of the present disclosure can be implemented or performed. The general purpose processor may be a microprocessor or any conventional processor. The operations of the methods disclosed in the embodiments of the present disclosure may be directly embodied as being performed and completed by a hardware decoding processor, or by a combination of hardware and software modules in the decoding processor. The software modules can be located in a known storage medium in the related art, such as random access memory, flash memory, read-only memory, programmable read-only memory, electrically erasable programmable memory, or register. The storage medium can be located in the memory, and the processor can read information from the memory and perform the operations of the above methods in combination with its hardware.

It can be appreciated that the memory in the embodiments of the present disclosure may be a volatile memory or a non-volatile memory, or may include both volatile and non-volatile memories. Here, the non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), which is used as an external cache. As illustrative, rather than limiting, examples, many forms of RAMs are available, including Static RAM (SRAM), Dynamic RAM (DRAM), Synchronous DRAM (SDRAM), Double Data Rate SDRAM (DDR SDRAM), Enhanced SDRAM (ESDRAM), Synchlink DRAM (SLDRAM)), and Direct Rambus RAM (DR RAM). It is to be noted that the memory used for the system and method described in the present disclosure is intended to include, but not limited to, these and any other suitable types of memories.

It can be appreciated that the above memories are exemplary only, rather than limiting the present disclosure. For example, the memory in the embodiment of the present disclosure may also be a Static RAM (SRAM), a Dynamic RAM (DRAM), a Synchronous DRAM (SDRAM), a Double Data Rate SDRAM (DDR SDRAM), an Enhanced SDRAM (ESDRAM), a Synch Link DRAM (SLDRAM), or a Direct Rambus RAM (DR RAM). That is, the memory in the embodiments of the present disclosure is intended to include, but not limited to, these and any other suitable types of memories.

An embodiment of the present disclosure also provides a computer readable storage medium for storing a computer program.

In some embodiments, the computer readable storage medium can be applied to the network device in the embodiment of the present disclosure, and the computer program can cause a computer to perform corresponding processes implemented by the network device in the method according to any of the embodiments of the present disclosure. Details thereof will be omitted here for simplicity.

In some embodiments, the computer readable storage medium can be applied to the mobile terminal/terminal device in the embodiment of the present disclosure, and the computer program can cause a computer to perform corresponding processes implemented by the mobile terminal/terminal device in the method according to any of the embodiments of the present disclosure. Details thereof will be omitted here for simplicity.

An embodiment of the present disclosure also provides a computer program product including computer program instructions.

In some embodiments, the computer program product can be applied to the network device in the embodiment of the present disclosure, and the computer program instructions can cause a computer to perform corresponding processes implemented by the network device in the method according to any of the embodiments of the present disclosure. Details thereof will be omitted here for simplicity.

In some embodiments, the computer program product can be applied to the mobile terminal/terminal device in the embodiment of the present disclosure, and the computer program instructions can cause a computer to perform corresponding processes implemented by the mobile terminal/terminal device in the method according to any of the embodiments of the present disclosure. Details thereof will be omitted here for simplicity.

An embodiment of the present disclosure also provides a computer program.

In some embodiments, the computer program can be applied to the network device in the embodiment of the present disclosure. The computer program, when executed on a computer, can cause the computer to perform corresponding processes implemented by the network device in the method according to any of the embodiments of the present disclosure. Details thereof will be omitted here for simplicity.

In some embodiments, the computer program can be applied to the mobile terminal/terminal device in the embodiment of the present disclosure. The computer program, when executed on a computer, can cause the computer to perform corresponding processes implemented by the mobile terminal/terminal device in the method according to any of the embodiments of the present disclosure. Details thereof will be omitted here for simplicity.

It can be appreciated by those skilled in the art that units and algorithm operations in the examples described in connection with the embodiments disclosed herein can be implemented in electronic hardware or any combination of computer software and electronic hardware. Whether these functions are executed by hardware or software depends on specific applications and design constraint conditions of the technical solutions. Those skilled in the art may use different methods for each specific application to implement the described functions, and such implementation is to be encompassed by the scope of this disclosure.

Those skilled in the art can clearly understand that, for the convenience and conciseness of the description, for the specific operation processes of the systems, devices, and units described above, reference can be made to the corresponding processes in the foregoing method embodiments, and details thereof will be omitted here.

In the embodiments of the present disclosure, it can be appreciated that the disclosed systems, devices, and methods may be implemented in other ways. For example, the device embodiments described above are illustrative only. For example, the divisions of the units are only divisions based on logical functions, and there may be other divisions in actual implementations. For example, more than one unit or component may be combined or integrated into another system, or some features can be ignored or omitted. In addition, the mutual coupling or direct coupling or communicative connection as shown or discussed may be indirect coupling or communicative connection between devices or units via some interfaces which may be electrical, mechanical, or in any other forms.

The units described as separate components may or may not be physically separated, and the components shown as units may or may not be physical units, that is, they may be co-located or distributed across a number of network elements. Some or all of the units may be selected according to actual needs to achieve the objects of the solutions of the embodiments.

In addition, the functional units in the embodiments of the present disclosure may be integrated into one processing unit, or alternatively be separate physical modules, or two or more units may be integrated into one unit.

When the function is implemented in the form of a software functional unit and sold or used as a standalone product, it can be stored in a computer readable storage medium. Based on this understanding, all or part of the technical solutions according to the embodiments of the present disclosure, or the part thereof that contributes to the prior art, can be embodied in the form of a software product. The computer software product may be stored in a storage medium and contain instructions to enable a computer device, such as a personal computer, a server, or a network device, etc., to perform all or part of the operations of the method described in each of the embodiments of the present disclosure. The storage medium may include a Universal Serial Bus flash drive, a mobile hard disk, a Read-Only Memory (ROM), a Random Access Memory (RAM), a magnetic disk, an optical disc, or any other medium capable of storing program codes.

While the specific embodiments of the present disclosure have been described above, the scope of the present disclosure is not limited to these embodiments. Various variants and alternatives can be made by those skilled in the art without departing from the scope of the present disclosure. These variants and alternatives are to be encompassed by the scope of present disclosure as defined by the claims as attached.

What is claimed is:

1. A wireless communication method, comprising:
receiving, by a network device, first information transmitted by a terminal device, the first information indicating a parameter the terminal device expects the network device to configure for a Multimedia Broadcast Multicast Service (MBMS) transmission.

2. The method according to claim 1, wherein the first information comprises at least one list of MBMS frequency on which the terminal device expects to receive an MBMS service.

3. The method according to claim 2, wherein the at least one list of MBMS frequency comprises at least one of:
a list of MBMS frequency corresponding to each terminal device;
a list of MBMS frequency corresponding to each frequency range;
a list of MBMS frequency corresponding to each band combination; or
at least one list of MBMS frequency for an MBMS receive only mode.

4. The method according to claim 1, wherein the first information comprises reception priority information of the MBMS service,
wherein the reception priority information of the MBMS service comprises first reception priority order information indicating a reception priority order of MBMS services and unicast services.

5. The method according to claim 4, wherein the reception priority information of the MBMS service comprises third reception priority order information indicating a reception priority order of MBMS services and unicast services on a plurality of systems.

6. The method according to claim 4, wherein the reception priority information of the MBMS service comprises fourth reception priority order information indicating a reception priority order of services on at least one list of MBMS frequency,
wherein the fourth reception priority order information is determined according to at least one of:
a service load on each list of MBMS frequency;
a type of service on each list of MBMS frequency; or
a Quality of Service (QoS) requirement for a service on each list of MBMS frequency.

7. The method according to claim 1, wherein the first information comprises at least one of:
a center frequency, a Subcarrier Spacing (SCS), an operating bandwidth, or a parameter related to a Bandwidth Part (BWP).

8. The method according to claim 1, wherein the first information comprises a type of MBMS service the terminal device expects to receive.

9. The method according to claim 1, further comprising:
receiving, by the network device, a request message transmitted by the terminal device, the request message being used to request release of a target bearer and/or a target service.

10. A terminal device, comprising a processor and a memory, wherein the memory has a computer program stored thereon, and the processor is configured to invoke and execute the computer program stored in the memory to:
transmit first information to a network device, the first information indicating a parameter the terminal device expects the network device to configure for a Multimedia Broadcast Multicast Service (MBMS) transmission.

11. The terminal device according to claim 10, wherein the first information comprises at least one list of MBMS frequency on which the terminal device expects to receive an MBMS service.

12. The terminal device according to claim 11, wherein the at least one list of MBMS frequency comprises at least one of:
a list of MBMS frequency corresponding to each terminal device;
a list of MBMS frequency corresponding to each frequency range;
a list of MBMS frequency corresponding to each band combination; or
at least one list of MBMS frequency for an MBMS receive only mode.

13. The terminal device according to claim 10, wherein the first information comprises reception priority information of the MBMS service,
wherein the reception priority information of the MBMS service comprises first reception priority order information indicating a reception priority order of MBMS services and unicast services.

14. The terminal device according to claim 13, wherein the reception priority information of the MBMS service comprises third reception priority order information indicating a reception priority order of MBMS services and unicast services on a plurality of systems.

15. The terminal device according to claim 13, wherein the reception priority information of the MBMS service comprises fourth reception priority order information indicating a reception priority order of services on at least one list of MBMS frequency,
wherein the fourth reception priority order information is determined according to at least one of:
a service load on each list of MBMS frequency;
a type of service on each list of MBMS frequency; or
a Quality of Service (QoS) requirement for a service on each list of MBMS frequency.

16. The terminal device according to claim 10, wherein the processor is further configured to invoke and execute the computer program stored in the memory to:
determine a target service and/or a target bearer to request the network device to release,
wherein the processor is further configured to invoke and execute the computer program stored in the memory to:
determine the target service and/or the target bearer to request the network device to release according to reception priority information of the MBMS service.

17. The terminal device according to claim 10, wherein the first information comprises at least one of:
a center frequency, a Subcarrier Spacing (SCS), an operating bandwidth, or a parameter related to a Bandwidth Part (BWP).

18. The terminal device according to claim 10, wherein the first information comprises a type of MBMS service the terminal device expects to receive.

19. A network device, comprising a processor and a memory, wherein the memory has a computer program stored thereon, and the processor is configured to invoke and execute the computer program stored in the memory to:
receive first information transmitted by a terminal device, the first information indicating a parameter the terminal device expects the network device to configure for a Multimedia Broadcast Multicast Service (MBMS) transmission.

20. The network device according to claim 19, wherein the first information comprises at least one list of MBMS frequency on which the terminal device expects to receive an MBMS service.
